(19) United States
(12) Patent Application Publication
(10) Pub. No.: US 2002/0052698 A1
(43) Pub. Date: May 2, 2002

(54) Exhaust opacity measuring device

(76) Inventors: John Didomenico, Tucson, AZ (US); James H. Johnson, Tucson, AZ (US); Donald H. Stedman, Denver, CO (US); Gary A. Bishop, Louisville, CO (US); Craig S. Rendahl, Tucson, AZ (US)

Correspondence Address: MINTZ LEVIN COHN FERRIS GLOVSKY AND POPEO PC, ONE FOUNTAIN SQUARE, 11911 FREEDOM DRIVE, SUITE 400, RESTON, VA, 20190, US

(21) Appl. No.: 09/818,664

(22) Filed: Mar. 28, 2001

Related U.S. Application Data
(63) Continuation of application No. 09/621,869, filed on Jul. 21, 2000.
Application No. 09/621,869 is a continuation of application No. 09/457,391, filed on Dec. 9, 1999, now abandoned.
(60) Provisional application No. 60/111,959, filed on Dec. 11, 1998.

(51) Int. Cl. G06F 19/00; G01N 31/00

(52) U.S. Cl. 702/31

(57) ABSTRACT

A remote emissions sensing system and method for sensing exhaust emissions from motor vehicles is provided where the system determines the opacity of an exhaust plume. The system comprises a radiation source that emits radiation which is passed through the exhaust plume of a motor vehicle to one or more detectors arranged to receive the radiation. A processor calculates the difference between the intensity of source radiation and the intensity of the radiation received by the detectors in first and second detection bands. The intensity difference in the second detection band measures exhaust opacity. If the exhaust opacity exceeds a predetermined level, the emissions data from other detection bands may be flagged as suspect or discarded. Alternatively, for a diesel powered vehicle, the exhaust opacity determination can be validated by a measurement of carbon monoxide in the exhaust plume.

### FIELD OF THE INVENTION

The present invention relates to a remote emissions sensing system and method for sensing exhaust emissions from motor vehicles where the system determines the opacity of an exhaust plume.

### BACKGROUND OF THE INVENTION

Remote emission sensing (RES) systems are known. One such system is disclosed in U.S. Pat. No. 5,210,702 and comprises an electromagnetic (EM) radiation source that is arranged to pass a beam of EM radiation through the exhaust plume of a motor vehicle as the motor vehicle passes by the system. The system also comprises one or more detectors arranged to receive the radiation after it passes through the exhaust plume of the vehicle. One or more filters may be associated with the one or more detectors to enable the detectors to determine the intensity of EM radiation having a particular wavelength or range of wavelengths. The wavelengths may be conveniently selected to correspond to wavelengths absorbed by molecular species of interest in an exhaust plume (e.g., hydrocarbons (HC), carbon monoxide (CO), carbon dioxide (CO₂) and nitrogen oxides (NOₓ) such as NO and NO₂. The one or more detector output voltages represent the intensity of the EM radiation measured by that detector.

These voltages are then input to a processor. The processor calculates the difference between the known intensity of the light source and the intensity detected by the detectors to determine the amount of absorption by the particular molecular species (based on predetermined wavelengths associated with that species). Based on the measured absorption(s), the concentration of one or more molecular species in the emissions may be determined in a known manner.

A system for the remote sensing of exhaust opacity is disclosed in “Feasibility of Remote Sensing of Particulate Emissions From Heavy-Duty Vehicles,” Chen, G. et al., American Society of Automotive Engineers (1996). In this system, opacity is measured at a wavelength of 710 nm and correlated with CO₂ measurements.

Existing RES systems suffer from various drawbacks and limitations. These factors may lead to erroneous readings, a relatively high incidence of discarded data or a relatively high incidence of “flagged” test results. These and other problems can reduce the benefits of an RES system.

At least some RES systems work, in part, by determining the absorption (or transmittance) of light through an exhaust plume. By determining the absorption/transmittance at particular wavelengths (corresponding to wavelengths at which various molecular species present in an exhaust plume absorb EM radiation), the concentration of those species in the exhaust can be determined. One problem is that various outside factors may affect the measured intensity and lead to errors. For example, if the measured intensity is reduced due to light scattering by particles in the exhaust plume, rather than absorption of the radiation by the species of interest, this can lead to errors. These and other drawbacks exist.

### SUMMARY OF THE INVENTION

An object of the present invention is to overcome these and other drawbacks in existing devices.

Another object of the present invention is to provide a remote emissions sensing system and method that is capable of remotely monitoring the opacity of exhaust from vehicles.

Another object of the present invention is to improve the accuracy of remote emissions sensing systems and methods by measuring exhaust opacity and utilizing that measured exhaust opacity to ensure the accuracy of other measurements.

Another object of the present invention is to provide existing emission monitoring equipment with exhaust opacity monitoring capability.

These and other objects of the invention are accomplished according to various embodiments of the present invention. According to one embodiment, a RES system and method comprises a radiation source that is arranged to pass a beam of radiation through the exhaust plume of a motor vehicle as the motor vehicle passes by the system. One or more detectors are arranged to receive the radiation after it passes through the exhaust plume of the vehicle.

The one or more detectors output a voltage corresponding to the intensity of the radiation received by that detector. These voltages are then input to a processor. The processor calculates the difference between the known intensity of the light source and the intensity detected by the detectors to determine the amount of absorption by the particular molecular species (based on predetermined wavelengths associated with that species). Based on the measured absorption(s), the concentration of one or more molecular species in the emissions may be determined.

According to one aspect of the invention, the output of a reference detector is supplied to a processor and monitored by the processor to determine the opacity of each exhaust plume. Based on the measured opacity, a predetermined action may be taken. For example, if the exhaust opacity exceeds a predetermined level, the emissions data may be analyzed to produce test results (in a known manner), but the test results may be “flagged” as suspect or discarded.

Other objects and advantages of the present invention will be apparent to one of ordinary skill in the art upon reviewing the description herein.

### BRIEF DESCRIPTION OF THE DRAWINGS

FIG. 1 depicts a remote emissions sensing device (RES) according to one embodiment of the present invention.

FIG. 2 depicts a data analysis method according to one embodiment of the present invention.

FIG. 3 depicts a processing system according to one embodiment of the present invention.

FIG. 4 depicts a flow diagram of a method according to one embodiment of the present invention.

### DETAILED DESCRIPTION OF THE PREFERRED EMBODIMENTS

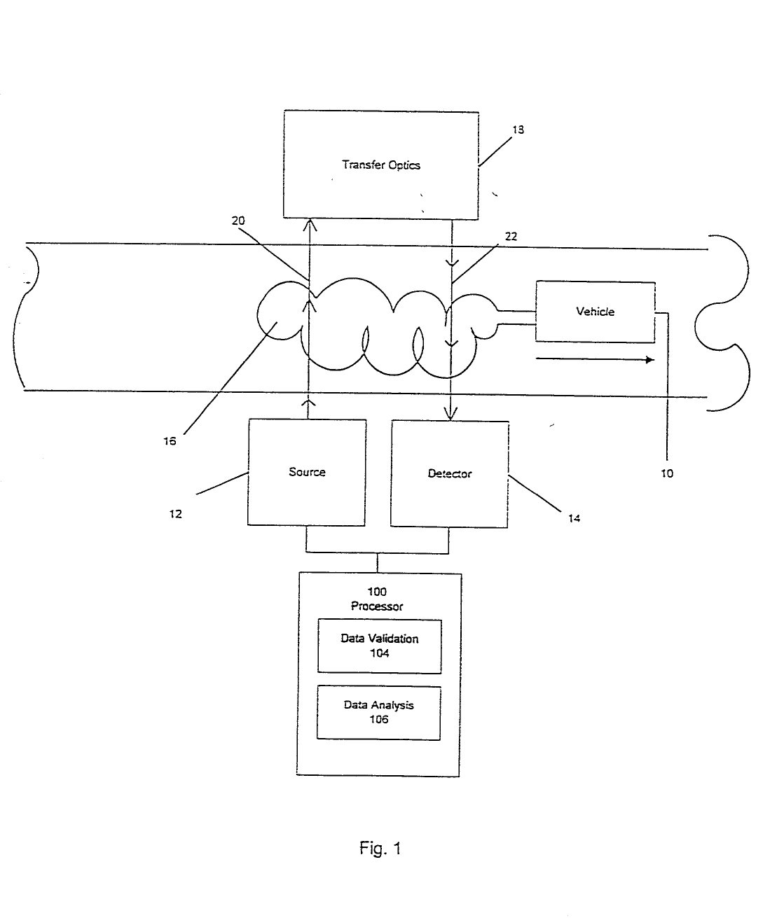

FIG. 1 depicts an RES according to one embodiment of the present invention. The RES measures emissions from a vehicle 10. The RES comprises a source 12 for generating radiation 20. Radiation 20 is directed through the exhaust plume 16 of a vehicle 10 as vehicle 10 passes by the RES. Transfer optics 18 receive the radiation 20 and transfer the radiation 20 through plume 16 as return radiation 22 to one or more detectors 14. Detectors 14 are arranged to measure said return radiation 22 after it passes through exhaust plume 16 of vehicle 10. A filter (not shown) may be associated with one or more detectors 14 to enable detector 14 to determine the intensity of radiation having a particular wavelength or range of wavelengths by filtering out all but the particular wavelength or range of wavelengths from return radiation 22. Alternatively, tuned lasers can be employed as source 12 to generate radiation 20 of a particular wavelength or range of wavelengths, in which case filters will not be required.

The wavelengths may be conveniently selected to correspond to wavelengths absorbed by molecular species of interest in an exhaust plume (e.g., HC, CO, CO₂, NO, NO₂ (hereinafter NOₓ), or other molecular species). One or more detector output voltages representing the intensity of the radiation 22 measured by that detector 14 are obtained. The detector output voltages are input into a processor 100. Detectors 14 may be any suitable detector such as a spectrometer, indium antimonide, or other known photovoltaic detectors.

Preferably, the source 12 is maintained at a substantially constant temperature by, for example, enclosing source 12 in a housing to insulate it from atmospheric conditions such as sun, wind and rain. Temperature variations at source 12 may introduce additional error in the measurements.

Processor 100 may calculate the difference between the original intensity of the radiation 20 and the intensity of the radiation 22 detected by detector 14 to determine the amount of radiation absorption by particular molecular species at predetermined wavelengths associated with that species. Based on the measured absorption(s), the concentration of one or more molecular species in the emissions may be determined in a known manner. Such systems generally take a plurality of measurements (e.g., 50) over a predetermined period of time (e.g., 0.5 seconds). These data points are then correlated and analyzed to determine concentrations of target emissions species.

According to one embodiment of the present invention, processing system 100 may perform various functions including determining concentrations of various emission components. As discussed above, the device of FIG. 1 monitors several channels, each for a separate emission component.

According to one embodiment of the present invention, the RES may be used for diesel vehicles, and particularly heavy-duty diesel vehicles such as trucks and buses. The present invention may be used to measure the concentration of various emission components as well as the amount of particulate emissions in the exhaust of a diesel vehicle. Gaseous and particulate emissions together contribute a substantial amount of pollutants to the environment. In particular, heavy-duty diesel vehicles produce a substantial amount of NOₓ as well as particulate emissions. Due to the probable carcinogenic nature of diesel particulate emissions, stringent regulations are generally imposed on such emissions.

Exhaust opacity is a measurement of the particulate emissions from a vehicle.

In measuring the opacity of vehicle emissions, an opacity measurement, a CO measurement and a CO₂ measurement may be taken to obtain a reliable and accurate measure of opacity. Any measurement of opacity inherently contains a certain error factor which results from the dilution of the exhaust plume with ambient air. A corresponding measurement of CO₂ concentration taken at the same time as the opacity measurement will reflect the same dilution of the exhaust plume by ambient air. Based upon a predetermined expectation of the level of CO₂ in an exhaust plume, and taking a ratio of the opacity measurement and a CO₂ measurement, the dilution factor is reduced thereby resulting in an accurate measurement of opacity.

The opacity measurement may be further verified in the case of diesel powered vehicles by comparing it to a CO measurement taken from the same exhaust plume at substantially the same time. The amount of CO in the plume is proportional to the amount of opacity of the plume. Therefore, if the amount of opacity is high, the amount of CO should also be high. If the amount of CO is low, while the amount of opacity is measured to be high, this may serve as an indication of a possible error in the opacity measurement or possible interference with the measurement due to other factors.

In a more preferred embodiment, a separate opacity channel is employed to determine opacity. The separate channel preferably uses radiation of wavelengths of about 0.30-1.50 microns. This wavelength range is expected to provide more accurate opacity measurements. Such a system may also include at least a CO₂, CO and reference channel. In this case, the reference channel is employed to monitor ambient noise and/or correct for low levels of particulate matter present in the exhaust plume.

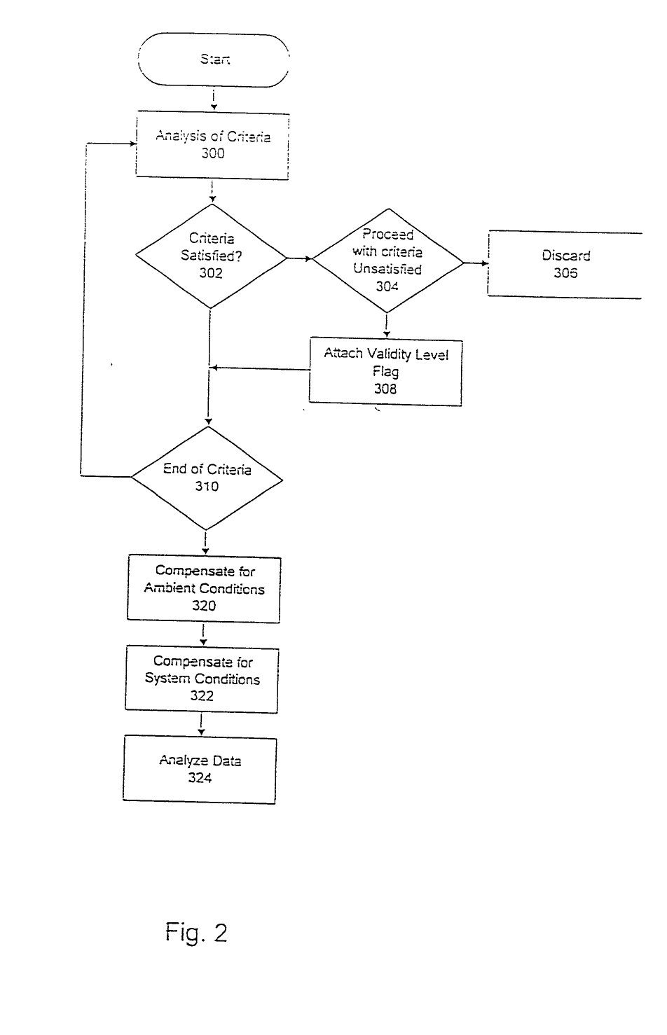

According to one embodiment of the present invention, a method for analyzing emissions may be described with reference to FIG. 2. In step 300, certain criteria are provided. The criteria used to analyze the measurement may vary depending on the particular emission concerned. In step 302, if the criteria are satisfied, then in step 310, the process proceeds back to step 300 to determine if more criteria are left to be analyzed. That process continues until, in step 310, there are no more criteria to analyze.

In step 302, if the criteria are not satisfied, then the process determines in step 304 whether the criteria are unsatisfied to a point where they are to be discarded in step 306 or whether they are to be simply flagged in step 308.

After criteria have been satisfied, in step 320, the results may be compensated for ambient conditions. In step 322, the system compensates for system conditions and in step 324, the data may further be analyzed. This overall method will be better understood with reference to the following embodiment of the present invention.

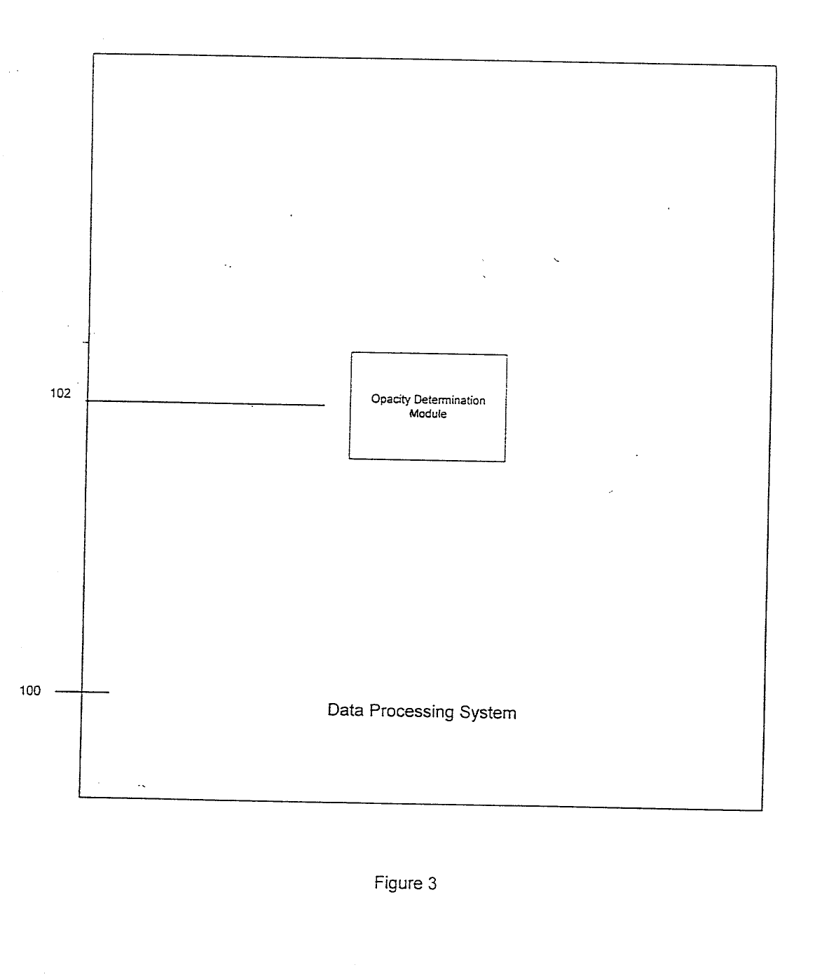

According to one embodiment of the present invention, the criteria may comprise opacity validation. According to this embodiment, the outputs of the one or more detectors of the RES system are input to processor 100 as depicted in FIG. 3. Processor 100 may comprise an exhaust opacity determination unit 102. Processor 100 may perform various known functions including determining concentrations of various gaseous emissions. Additionally, processor 100 may also determine exhaust opacity from the measurements taken, through exhaust opacity determination unit 102.

According to one embodiment, exhaust opacity determination unit 102 may determine exhaust opacity using the reference channel of the RES system by taking measurements of opacity at a wavelength of about 3.9 um. Exhaust opacity determination unit 102 receives measurements from the reference channel and at least one other channel of interest. According to one embodiment, the channel of interest may be the CO₂ channel.

For each particular time interval measured, if the intensity of the reference channel is less than the input intensity of the radiation 20 normally generated by the radiation source 12, then processor 100 compares the reference channel intensity attenuation with that on the CO₂ channel. If the detected intensity of the reference channel drops, it is determined that particles in the exhaust plume are blocking or deflecting a portion of the radiation 20 which then does not return to the detector 14 as return radiation 22. Opacity results from radiation scattering and absorption by the particulate matter present in the exhaust plume.

According to one embodiment of the present invention, the output of one or more of the detectors may be used in determining the opacity of the exhaust plume emanating from a vehicle being tested. The output of the detector (voltage level) may be monitored by processor 100. A voltage drop in the reference channel may be used to indicate and determine opacity of the exhaust. Accordingly, the wavelength or wavelength band detected by the reference channel may be specifically selected so that components of the emission, including CO₂, CO, HC, and NOₓ, do not interfere with the opacity readings.

The determination of opacity in an exhaust plume may include the exhaust from heavy-duty diesel vehicles where the exhaust may comprise particles, such as dry soot. Generally, most diesel particles may range from 0.02-0.5 microns in size. According to the present invention, the output of one or more detectors may be used to calculate the opacity of the exhaust plume of a heavy-duty diesel vehicle being tested. The output of the detector may be monitored by processor 100 for changes in radiation intensity due to particles, such as soot, of the diesel exhaust plume. The degree of change in radiation intensity detected may then be used to measure the opacity of the diesel exhaust emission.

Measured reductions in the reference channel intensity may be used to correct gas measurement wavelengths for ambient noise, opacity and other factors because pollutant gases do not absorb at the reference wavelength. The measured pollutant wavelength absorptions may then be converted to apparent concentration values. If at least one of the apparent concentration values exceed a predetermined minimum, the pollutant concentrations may be correlated with the measured CO₂. The slopes are the ratios of the measured pollutants to the measured CO₂. These slopes can be used to carry out other calculations as described elsewhere herein.

In a more preferred embodiment, the opacity measurement is employed to validate measurements of the other components in the exhaust plume. A high opacity value indicates the presence of a large amount of particulate matter in the exhaust plume which may result in the scattering or absorption of radiation at one or more of the characteristic wavelengths for various components of the exhaust plume. This may cause inaccurate readings for these various components.

In such a case, the RES may label readings taken when a high opacity is present as suspect or invalid. More preferably, these readings are labeled invalid and additional readings are taken after a time delay to allow a significant portion of the particulate matter to settle out of the exhaust plume. To implement this, the RES can monitor opacity and/or CO readings until opacity and/or CO concentration fall below a predetermined level deemed to be acceptable for taking readings for various exhaust components such as CO, CO₂, HC, NO and NO₂. The presence of sufficient plume for the measurements after the time delay can be verified using the CO₂ reading since the expected CO₂ concentration of a particular vehicle exhaust plume can be estimated from factors such as the vehicle type, the fuel type, ambient conditions, etc. In this manner, the RES may provide accurate measurements of exhaust components even when the initial exhaust plume has a high opacity that would normally introduce a significant error into such measurements.

Percent opacity is subject to rapid attenuation by various factors, such as air, wind, and turbulence behind the vehicle. Since CO₂ readings can be used as a tracer of where the exhaust plume is seen, if the correlation to CO₂ is not accurate (i.e., there is a large error in the slope), then the opacity measurement may be presumed as from being from another source, such as dirt from tires, and the reading is rejected. If the correlation is accurate (i.e., there is a small error in the slope), then multiplication of the measured slope by a correction factor, such as 1000, depending on the calibrations and the units of measurement used, leads to a standardized opacity.

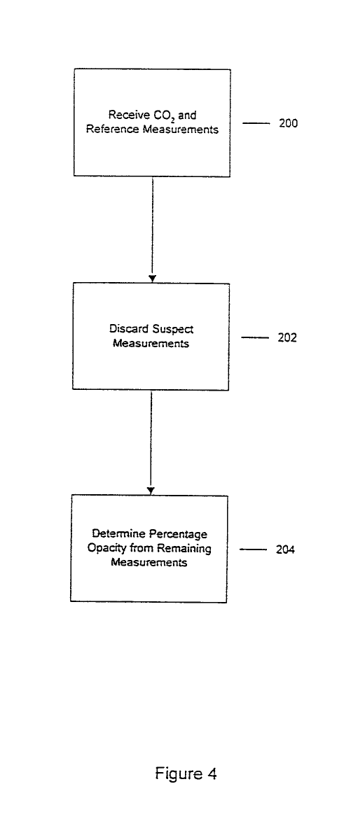

FIG. 4 depicts a flow diagram of a method for detecting exhaust opacity according to an embodiment of the present invention. In step 200, the output of a reference channel and one or more emission channels, for example, the CO₂ channel, may be received by processor 100. Various validation, error prevention or signal processing routines may be performed on the data to ensure that the plume is sufficient for making an opacity determination. In step 202, if these validation routines determine that the plume is insufficient then the plume may be labeled as suspect or discarded to prevent erroneous opacity measurements.

If, however, the measurements are validated, then in step 204, processor 100 may determine percentage opacity from the remaining measurements. Specifically, percentage opacity may be determined by calculating the slope of the reference channel output versus the slope of the CO₂ channel output. In addition, these results may be converted to provide a Ringelman scale equivalent. Simply stated, a Ringelman scale equivalent is determined by equating percentage opacity to a number between 0 and 5. The Ringelman scale compared to the opacity may be as follows:

| Opacity | Ringelman Equivalent |
|---|---|
| 0% | 0 |
| 15% | 1 |
| 30% | 2 |
| 50% | 3 |
| 70% | 4 |
| 100% | 5 |

After the percentage opacity is determined, it may be desired to validate the opacity measurements through one or more validation routines. Specifically, according to one embodiment, all percentage opacities below a predetermined amount should be labeled as suspect. In one embodiment, the predetermined amount may be −5.0%, although other values may also be used.

Additionally, in determining the reference slope using least squares, a slope error value may also be determined according to known methods. Based on that slope error, an opacity error value is determined by multiplying this value by a predetermined value. According to one embodiment, the predetermined factor may be 1000, for example. According to another embodiment of the present invention, the factor may be 100. If this opacity error value exceeds a predetermined value, then the percentage opacity measurement is labeled as suspect. The predetermined value for the opacity error may be 2%, for example.

Also, percentage opacity measurements above a certain level of opacity may be labeled as suspect or discarded. For example, it may be determined that a measurement of greater than about 50% opacity should be discarded because it is likely that such a high amount of opacity would not be readable accurately and instead may indicate light blockage or another type of temporary problem that does not reflect opacity of the exhaust stream. Other predetermined values, such as 70%, 80%, 90% or 100%, for example, may also be used.

In the case of diesel powered vehicles, the most preferred validation method is to compare the opacity measurement to a measurement of CO taken at the same time since there is a correlation between CO emissions and exhaust opacity for diesel vehicles. Using this method, predetermined correlations between CO and opacity measurements can be used to determine whether a particular opacity measurement should be considered valid, suspect or invalid.

Accordingly, a device according to the present invention may remotely determine opacity over a brief time interval from a moving vehicle. Further, because many existing emission monitoring devices utilize a reference channel for other purposes, a device according to the present invention may be utilized with existing systems to provide opacity measurements. According to one embodiment, use of data processing system 100 with existing systems permits an existing emission monitoring system to monitor opacity as well. Therefore, replacement costs may be minimized.

Other embodiments and uses of the invention will be apparent to those skilled in the art from consideration of the specification and practice of the invention disclosed herein. The specification and examples should be considered exemplary only. The scope of the invention is only limited by the claims appended hereto.

What is claimed is:

1. A remote sensing system for remotely determining the opacity of a vehicle exhaust plume comprising:
a radiation source arranged to pass radiation through an exhaust plume of a motor vehicle;
one or more detectors arranged to receive the radiation after it passes through the exhaust plume of the motor vehicle and generate at least one signal indicative of the intensity of radiation in at least two different detection bands received at the one or more detectors;
a first of said detection bands being selected to include a wavelength at which there is substantial absorption of radiation by a gaseous component of a vehicle exhaust plume, and a second of said detection bands being selected to include a wavelength at which there is substantially no absorption of radiation by a gaseous component of a vehicle exhaust plume; and
a processor programmed to determine the difference between the intensity of the radiation provided by the radiation source in the at least two different detection bands and the intensity of the radiation received by the one or more detectors in the at least two detection bands, based on the at least one signal generated by the one or more detectors, and to disregard the radiation intensity measurement in the first of said detection bands for at least one component expected to be present in the vehicle exhaust plume based at least in part on the determined intensity difference in the second detection band.

2. The system of claim 1, wherein the processor compares the intensity difference in the second detection band to intensity difference in the first detection band to determine the exhaust opacity.

3. The system of claim 2, wherein intensity measurements for one or more gaseous components of the vehicle exhaust plume are flagged as suspect when the exhaust opacity exceeds a first predetermined level and are discarded when the exhaust opacity exceeds a second predetermined level.

4. The system of claim 2 wherein percentage opacity is determined from a ratio of the intensity difference in the second detection band to the intensity difference in the first detection band.

5. The system of claim 1 wherein the second detection band includes a wavelength in the range of from about 0.3 microns to about 1.5 microns.

6. The system of claim 5 further comprising apparatus for insulating the source of radiation from ambient environmental conditions to minimize temperature changes in the radiation source.

7. A remote sensing system for remotely determining the opacity of a vehicle exhaust plume for a diesel powered vehicle comprising:
a radiation source arranged to pass radiation through an exhaust plume of a motor vehicle;
one or more detectors arranged to receive the radiation after it passes through the exhaust plume of the motor vehicle and generate at least one signal indicative of the intensity of radiation in at least two different detection bands received at the one or more detectors;
a first of said detection bands being selected to include a wavelength of radiation at which there is substantial absorption of radiation by carbon monoxide, and a second of said detection bands being selected to include a wavelength of radiation at which there is substantially no absorption of radiation by a gaseous component of a vehicle exhaust plume; and
a processor programmed to determine the difference between the intensity of the radiation provided by the radiation source in the at least two different detection bands and the intensity of the radiation received by the one or more detectors in the at least two detection bands, based on the at least one signal generated by the one or more detectors, and to disregard the radiation intensity measurement in the second of said detection bands for exhaust opacity based at least in part on the determined intensity difference in the first detection band.

8. The system of claim 7, wherein the exhaust opacity measurement is discarded based upon a variance from a predetermined correlation between the determined intensity difference in the first detection band and the determined intensity difference in the second detection band.

9. The system of claim 8, wherein the one or more detectors generate at least one signal indicative of the intensity of radiation in at least three different detection bands received at the one or more detectors;
the third detection band including a wavelength of radiation absorbed by carbon dioxide; and
wherein the processor compares the intensity difference in the third detection band to intensity difference in the second detection band to determine the exhaust opacity.

10. The system of claim 9, wherein intensity measurements for one or more gaseous components of the vehicle exhaust plume are flagged as suspect when the exhaust opacity exceeds a first predetermined level and are discarded when the exhaust opacity exceeds a second predetermined level.

11. The system of claim 9, wherein percentage opacity is determined from a ratio of the intensity difference in the third detection band to the intensity difference in the second detection band.

12. The system of claim 8, wherein the second detection band includes a wavelength in the range of from about 0.3 to about 1.5 microns.

13. The system of claim 12, further comprising apparatus for insulating the source of radiation from ambient environmental conditions to minimize temperature changes in the radiation source.

14. A method for remotely sensing exhaust emissions to determine the opacity of an exhaust plume from a motor vehicle comprising the steps of:
a) passing radiation from a radiation source through an exhaust plume of a motor vehicle;
b) receiving the radiation at one or more detectors after it passes through the exhaust plume of the motor vehicle;
c) generating at least a first signal indicative of the intensity of the radiation received at the one or more detectors in a first detection band which includes a wavelength at which there is substantial absorption of radiation by a gaseous component of the exhaust plume, and a second signal indicative of the intensity of the radiation received at the one or more detectors in a second detection band which includes a wavelength at which there is substantially no radiation absorbed by a gaseous component of the exhaust plume;
d) determining from the first and second generated signals the difference between the intensity of the source radiation and the intensity of the radiation received at the one or more detectors in the first and second detection bands;
e) comparing the determined differences in said first and second detection bands to obtain a measurement of the exhaust opacity; and
f) discarding the radiation intensity measurements in said first detection band if the exhaust opacity exceeds a predetermined threshold level.

15. The method of claim 14 further comprising the step of:
g) repeating steps a-f until the exhaust opacity no longer exceeds the predetermined threshold level.

16. The method of claim 15 further comprising the step of:
h) determining the concentration of at least one gaseous component of the vehicle exhaust plume from the determined intensity difference in at least one of the detection bands which contains a wavelength at which there is substantial absorption of radiation by that gaseous component of the exhaust plume.

17. The method of claim 16, wherein the first detection band includes a wavelength at which there is substantial absorption of radiation by carbon dioxide.

18. The method of claim 17 for use in determining the exhaust opacity of a diesel powered vehicle, further comprising the steps of:
generating a third signal indicative of the intensity of the radiation received at the one or more detectors in a third detection band which includes a wavelength at which there is substantial absorption of radiation by carbon monoxide;
determining from the third generated signals the difference between the intensity of the source radiation and the intensity of the radiation received at the one or more detectors in the third detection band;
validating the exhaust opacity by comparing the determined intensity difference in the third detection band with a predetermined correlation between exhaust opacity and carbon monoxide concentration.

19. The method of claim 17, wherein the second detection band comprises a wavelength in the range of from about 0.3 microns to about 1.5 microns.

20. A method for remotely sensing exhaust emissions to determine the opacity of an exhaust plume from a diesel powered vehicle comprising the steps of:
a) passing radiation from a radiation source through an exhaust plume of a motor vehicle;
b) receiving the radiation at one or more detectors after it passes through the exhaust plume of the motor vehicle;
c) generating at least a first signal indicative of the intensity of the radiation received at the one or more detectors in a first detection band which includes a wavelength at which there is substantial absorption of radiation by carbon monoxide, a second signal indicative of the intensity of the radiation received at the one or more detectors in a second detection band which includes a wavelength at which there is substantially no radiation absorbed by a gaseous component of the exhaust plume; and
d) determining from the first and second generated signals the difference between the intensity of the source radiation and the intensity of the radiation received at the one or more detectors in the first and second detection bands;
e) determining exhaust opacity from said intensity difference in said second detection band;
f) discarding the determined exhaust opacity if the intensity difference in the first detection band does not fall within a predetermined correlation with the exhaust opacity.

21. The method of claim 20 wherein the second detection band comprises a wavelength in the range of from about 0.3 microns to about 1.5 microns.
